(19) United States
(12) Patent Application Publication
(10) Pub. No.: US 2003/0187652 A1
(43) Pub. Date: Oct. 2, 2003

(54) Content recognition system for indexing occurrences of objects within an audio/video data stream to generate an index database corresponding to the content data stream

(75) Inventor: Bruce Alan Fairman, Woodside, CA (US)

Correspondence Address: Jonathan O. Owens, HAVERSTOCK & OWENS LLP, 162 North Wolfe Road, Sunnyvale, CA, 94086, US

(73) Assignees: Sony Corporation; Sony Electronics Inc.

(21) Appl. No.: 10/112,224

(22) Filed: Mar. 27, 2002

(51) Int. Cl. G10L 21/00

(52) U.S. Cl. 704/270

(57) ABSTRACT

A content recognition system for indexing occurrences of objects within an audio/video content data stream processes the stream of data to generate a content index database corresponding to the content stream. The content stream is processed by applying recognition technology to the content within the content stream to identify and index occurrences of identified objects. Preferably, the content stream is processed as the content stream is stored within a media storage device. Alternatively, the content stream is processed after the content stream is stored within the media storage device. The objects that are included within the index database, are either identified by the user before processing or are identified dynamically by the recognition technology during processing. As the content stream is processed, entries preferably including an object identifier and corresponding locations of that object, are generated within the index database. The content index database can then be used to quickly locate and navigate to specific occurrences of content and objects within the content stream.

### FIELD OF THE INVENTION

The present invention relates to the field of receiving, storing and transmitting content data streams. More particularly, the present invention relates to the field of receiving, storing, classifying, indexing and transmitting content data streams.

### BACKGROUND OF THE INVENTION

The IEEE standard, “IEEE 1394-2000 Standard For A High Performance Serial Bus,” Draft ratified in 2000, is an international standard for implementing an inexpensive high-speed serial bus architecture which supports both asynchronous and isochronous format data transfers. Isochronous data transfers are real-time transfers which take place such that the time intervals between significant instances have the same duration at both the transmitting and receiving applications. Each packet of data transferred isochronously is transferred in its own time period. The IEEE 1394-2000 standard bus architecture provides up to sixty-four (64) channels for isochronous data transfer between applications. A six bit channel number is broadcast with the data to ensure reception by the appropriate application. This allows multiple applications to simultaneously transmit isochronous data across the bus structure. Asynchronous transfers are traditional data transfer operations which take place as soon as possible and transfer an amount of data from a source to a destination.

The IEEE 1394-2000 standard provides a high-speed serial bus for interconnecting digital devices thereby providing a universal I/O connection. The IEEE 1394-2000 standard defines a digital interface for the applications thereby eliminating the need for an application to convert digital data to analog data before it is transmitted across the bus. Correspondingly, a receiving application will receive digital data from the bus, not analog data, and will therefore not be required to convert analog data to digital data. The cable required by the IEEE 1394-2000 standard is very thin in size compared to other bulkier cables used to connect such devices. Devices can be added and removed from an IEEE 1394-2000 bus while the bus is active. If a device is so added or removed the bus will then automatically reconfigure itself for transmitting data between the then existing nodes. A node is considered a logical entity with a unique identification number on the bus structure. Each node provides an identification ROM, a standardized set of control registers and its own address space.

The IEEE 1394-2000 standard defines a protocol as illustrated in FIG. 1. This protocol includes a serial bus management block 10 coupled to a transaction layer 12, a link layer 14 and a physical layer 16. The physical layer 16 provides the electrical and mechanical connection between a device or application and the IEEE 1394-2000 cable. The physical layer 16 also provides arbitration to ensure that all devices coupled to the IEEE 1394-2000 bus have access to the bus as well as actual data transmission and reception. The link layer 14 provides data packet delivery service for both asynchronous and isochronous data packet transport. This supports both asynchronous data transport, using an acknowledgement protocol, and isochronous data transport, providing real-time guaranteed bandwidth protocol for just-in-time data delivery. The transaction layer 12 supports the commands necessary to complete asynchronous data transfers, including read, write and lock. The serial bus management block 10 contains an isochronous resource manager for managing isochronous data transfers. The serial bus management block 10 also provides overall configuration control of the serial bus in the form of optimizing arbitration timing, guarantee of adequate electrical power for all devices on the bus, assignment of the cycle master, assignment of isochronous channel and bandwidth resources and basic notification of errors.

A typical hard disk drive including an IEEE 1394-2000 serial bus interface is illustrated in FIG. 2. The hard disk drive 20 includes the IEEE 1394-2000 serial bus interface circuit 22 for interfacing to an IEEE 1394-2000 serial bus network. The interface circuit 22 is coupled to a buffer controller 24. The buffer controller 24 is coupled to a random access memory (RAM) 26 and to a read/write channel circuit 28. The read/write channel circuit 28 is coupled to the media 30 on which data is stored within the hard disk drive 20. The read/write channel circuit 28 controls the storage operations on the media 30, including reading data from the media 30 and writing data to the media 30.

During a write operation to the hard disk drive 20, a stream of data is received from a device coupled to the IEEE 1394-2000 serial bus structure by the IEEE 1394-2000 interface circuit 22. This stream of data is forwarded from the IEEE 1394-2000 interface circuit 22 to the buffer controller 24. The buffer controller 24 then stores this data temporarily in a buffer in the RAM 26. When the read/write channel circuit 28 is available, the buffer controller 24 reads the data from the RAM 26 and forwards it to the read/write channel circuit 28. The read/write channel circuit 28 then writes the data onto the media 30. During a read operation from the hard disk drive 20, a stream of data is read from the media 30 by the read/write channel circuit 28. This stream of data is forwarded by the read/write channel circuit 28 to the buffer controller 24. The buffer controller 24 then stores this data temporarily in a buffer in the RAM 26. When the IEEE 1394-2000 serial bus interface circuit 22 is available, the buffer controller 24 reads the data from the RAM 26 and forwards it to the interface circuit 22. The IEEE 1394-2000 serial bus interface circuit 22 then formats the data according to the requirements of the IEEE 1394-2000 standard and transmits this data to the appropriate device or devices over the IEEE 1394-2000 serial bus.

A traditional hard disk drive 20, as described, records data and plays it back according to commands received from an external controller using a protocol such as the serial bus protocol (SBP). The external controller provides command data structures to the hard disk drive 20 which inform the hard disk drive 20 where on the media 30 the data is to be written, in the case of a write operation, or read from, in the case of a read operation. The function of the hard disk drive 20 during a read operation is to recreate the original, unmodified stream of data which was previously written on the media 30.

When accessing a stored audio/video stream from the hard disk drive, the user has the typical choices of normal playback, fast-forward and rewind. Currently, any indexing of such a stored audio/video stream is time based, such that a user has the ability to pick a point of time in the stored audio/video stream from which playback will start. There is currently no method of or apparatus for indexing a stored audio/video stream and locating specific points within the audio/video stream based on occurrences of content within the audio/video stream.

### SUMMARY OF THE INVENTION

A content recognition system for indexing occurrences of objects within an audio/video content data stream processes the stream of data to generate a content index database corresponding to the content stream. The content stream is processed by applying recognition technology to the content within the content stream to identify and index occurrences of identified objects. Preferably, the content stream is processed as the content stream is stored within a media storage device. Alternatively, the content stream is processed after the content stream is stored within the media storage device. The objects that are included within the index database, are either identified by the user before processing or are identified dynamically by the recognition technology during processing. As the content stream is processed, entries preferably including an object identifier and corresponding locations of that object, are generated within the index database. The content index database can then be used to quickly locate and navigate to specific occurrences of content and objects within the content stream.

In an aspect of the present invention a method of generating an index database representing a content stream, the method comprises receiving a content stream, processing the content stream to determine occurrences of one or more objects within the content stream and generating an entry within an index database for each occurrence of the one or more objects. The entry includes an object identifier and a corresponding location of the occurrence of the object within the content stream. The method further comprises playing back the content stream beginning at the location corresponding to a next occurrence of a specified object. The method further comprises storing the content stream. The method further comprises storing the index database. The method further comprises identifying the objects before the processing is performed or alternatively identifying the objects during the processing. The objects include one or more of shapes, objects, events and movements. The objects also include one or more of sounds, words and utterances. The content stream includes one or more of an audio component and a video component.

In another aspect of the present invention, a method of processing a content stream comprises processing a content stream to determine occurrences of one or more objects within the content stream and generating an entry for each occurrence of the one or more objects, the entry including an object identifier and a corresponding location of the occurrence of the object within the content stream. The method further comprises receiving the content stream. The method further comprises saving the entry within an index database. The method further comprises storing the content stream. The method further comprises identifying the objects before the processing is performed or during the processing. The objects include one or more of shapes, objects, events and movements. The objects also include one or more of sounds, words and utterances. The content stream includes one or more of an audio component and a video component.

In still another aspect of the present invention, a method of playing back a content stream from an occurrence of an object comprises locating an entry within an index database corresponding to the content stream, the entry including an object identifier and a corresponding location of the occurrence of the object within the content stream and playing back the content stream beginning at the location corresponding to a next occurrence of a specified object. The objects include one or more of shapes, objects, events and movements. The objects also include one more of sounds, words and utterances. The content stream includes one or more of an audio component and a video component.

In yet another aspect of the present invention, an apparatus for processing a content stream comprises means for processing a content stream to determine occurrences of one or more objects within the content stream and means for generating an entry coupled to the means for processing for generating an entry for each occurrence of the one or more objects, the entry including an object identifier and a corresponding location of the occurrence of the object within the content stream. The apparatus further comprises means for receiving coupled to the means for processing for receiving the content stream. The apparatus further comprises means for storing coupled to the means for receiving for storing the content stream. The means for storing includes a hard disk drive. The apparatus further comprises means for storing coupled to the means for generating for saving the entry within an index database. The objects are identified before the content stream is processed by the means for processing. The objects are identified by the means for processing as the content stream is processed by the means for processing. The means for processing includes a recognition engine. The recognition engine incorporates one or more of speech recognition, voice recognition and visual recognition. The objects include one or more of shapes, objects, events and movements. The objects also include one or more of sounds, words and utterances. The content stream includes one or more of an audio component and a video component.

In still yet another aspect of the present invention, an apparatus to process a content stream comprises a processing engine to process a content stream to determine occurrences of one or more objects within the content stream and a controller coupled to the processing engine to generate an entry for each occurrence of the one or more objects, the entry including an object identifier and a corresponding location of the occurrence of the object within the content stream. The apparatus further comprises an interface coupled to the processing engine configured to receive the content stream. The apparatus further comprises a storage device coupled to the interface to store the content stream. The storage device includes a hard disk drive. The storage device is remote from the processing engine and the controller. The storage device is alternatively coupled to the processing engine and the controller over an IEEE 1394 serial bus network. The apparatus further comprises a storage device coupled to the controller to save the entry within an index database. The objects are identified before the content stream is processed by the processing engine or by the processing engine as the content stream is processed by the processing engine. The processing engine includes a recognition engine. The recognition engine incorporates one or more of speech recognition, voice recognition and visual recognition. The objects include one or more of shapes, objects, events and movements. The objects also include one or more of sounds, words and utterances. The content stream includes one or more of an audio component and a video component.

In yet another aspect of the present invention, an index database corresponding to a content stream comprising a plurality of entries, each entry including an object identifier and a corresponding location of an occurrence of an object within the content stream. The objects include one or more of shapes, objects, events and movements. The objects also include one or more of sounds, words and utterances. The content stream includes one or more of an audio component and a video component. The entries are stored on a storage device. The storage device is a hard disk drive.

In still yet another aspect of the present invention, a storage device configured to store and process a content stream comprises a processing engine to process a content stream to determine occurrences of one or more objects within the content stream, a controller coupled to the processing engine to generate an entry for each occurrence of the one or more objects, the entry including an object identifier and a corresponding location of the occurrence of the object within the content stream and a storage element coupled to the processing engine and to the controller to store the content stream and the entries. The processing engine and the controller are remote from the storage element. The processing engine and the controller are alternatively coupled to the storage element over an IEEE 1394 serial bus network. The storage device further comprises an interface coupled to the processing engine and configured to receive the content stream. The interface receives the content stream over an IEEE 1394 serial bus network. The storage element includes a hard disk drive. The objects are identified before the content stream is processed by the processing engine or by the processing engine as the content stream is processed by the processing engine. The processing engine includes a recognition engine incorporating one or more of speech recognition, voice recognition and visual recognition. The objects include one or more of shapes, objects and movements. The objects also include one or more of sounds, words and utterances. The content stream includes one or more of an audio component and a video component.

In yet another aspect of the present invention, a network of devices comprises a source device for transmitting a content stream, a storage device coupled to the source device to receive and store the content stream and a controller coupled to the storage device to process the content stream to determine occurrences of one or more objects within the content stream and generate entries corresponding to the occurrences of the one or more objects, each of the entries including an object identifier and a corresponding location of the occurrence of the object within the content stream. The storage device is a hard disk drive. The objects are identified before the content stream is processed or by the controller as the content stream is processed. The controller includes a recognition engine incorporating one or more of speech recognition, voice recognition and visual recognition. The objects include one or more of shapes, objects, events and movements. The objects also include one or more of sounds, words and utterances. The content stream includes one or more of an audio component and a video component. The entries are stored on the storage device within an index database. The source device is coupled to the storage device over an IEEE 1394 serial bus network. The storage device is alternatively coupled to the controller over an IEEE 1394 serial bus network. The storage device is remote from the controller.

### BRIEF DESCRIPTION OF THE DRAWINGS

FIG. 1 illustrates a protocol defined by the IEEE 1394-2000 standard.

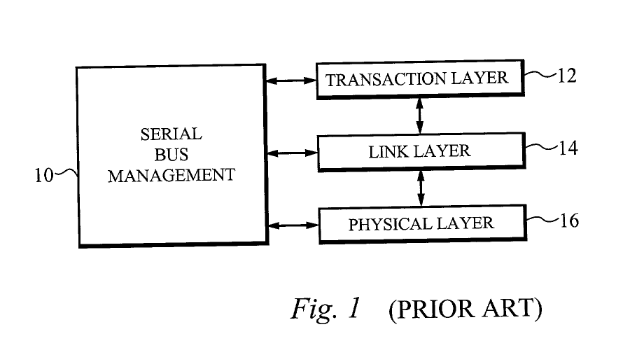

FIG. 2 illustrates a block diagram of a media storage device of the prior art.

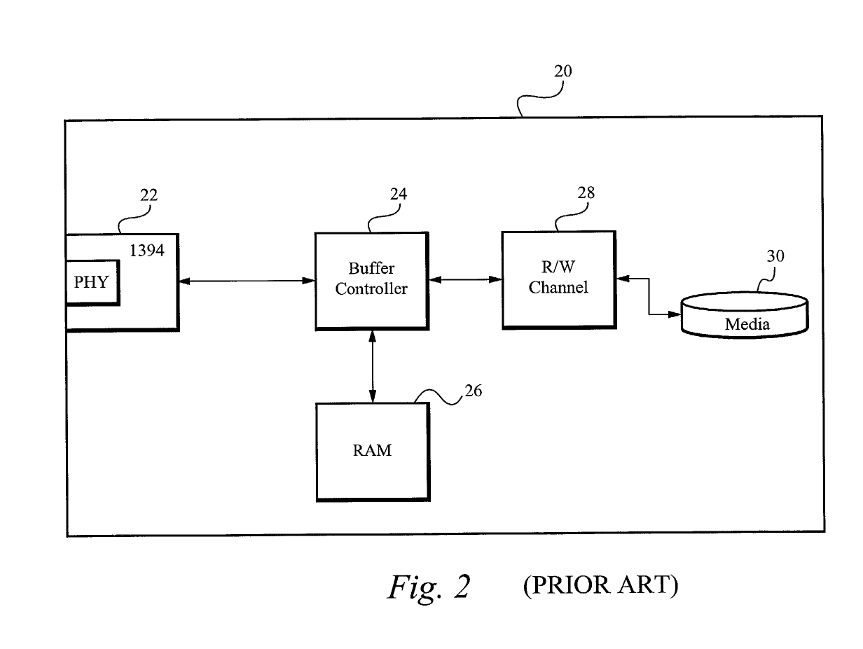

FIG. 3 illustrates a block diagram of a media storage device within external controller operating according to the present invention.

FIG. 4 illustrates a block diagram of the internal components of the computer system 60.

FIG. 5 illustrates an index database according to the preferred embodiment of the present invention.

FIG. 6 illustrates a flowchart showing the preferred steps implemented by the controller 60 and the media storage device 50 during processing of a content stream to generate an index database.

FIG. 7 illustrates a flowchart showing the preferred steps implemented by the controller 60 and the media storage device 50 during playback of a content stream.

### DETAILED DESCRIPTION OF THE PREFERRED EMBODIMENT

A content recognition system for indexing occurrences of objects within an audio/video content data stream processes the stream of data to generate a content index database corresponding to the content stream. The content stream is processed by applying recognition technology to the content within the content stream to identify and index occurrences of identified objects. Preferably, the content stream is processed as the content stream is stored within a media storage device. Alternatively, the content stream is processed after the content stream is stored within the media storage device. The objects that are included within the index database, are either identified by the user before processing or are identified dynamically by the recognition technology during processing. As the content stream is processed, an entry for each object is generated within the index database. Each entry preferably includes an object identifier and corresponding locations of that object. The locations preferably reference where the particular content is stored within the media storage device. Once the content index database is generated, it can then be used to quickly locate and navigate to specific occurrences of content and objects within the content stream. The objects that can be identified and indexed preferably include any identifiable information within a content stream, including shapes, objects, events and movements within video streams and sounds, words and utterances within audio streams. The content index database is preferably stored on the same media storage device as the content stream.

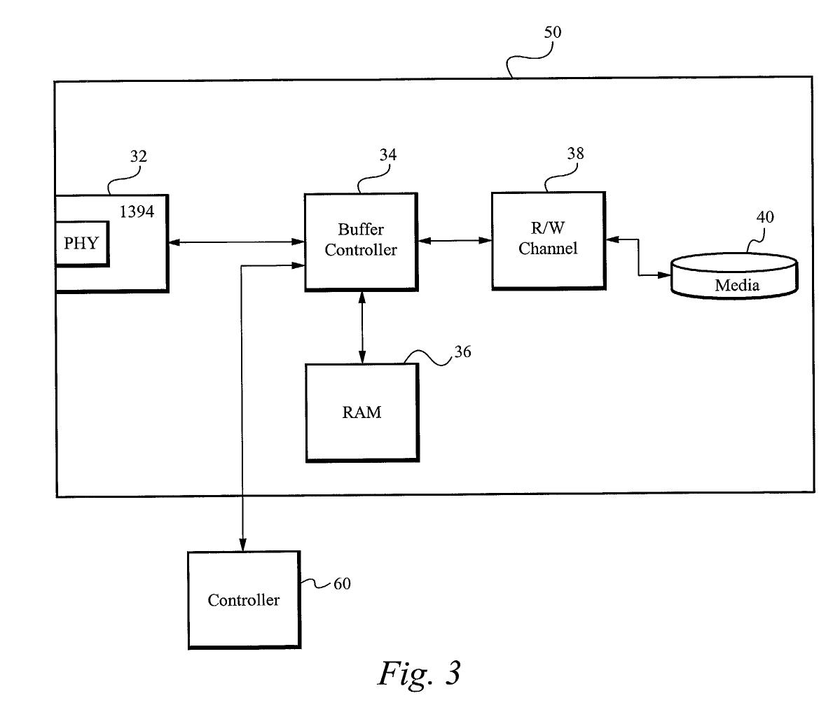

A media storage device with external controller operating according to the present invention is illustrated in FIG. 3. The media storage device 50 includes an IEEE 1394-2000 serial bus interface circuit 32 for sending communications to and receiving communications from other devices coupled to the IEEE 1394-2000 serial bus network. The interface circuit 32 is coupled to a buffer controller 34. The buffer controller 34 is also coupled to a RAM 36 and to a read/write channel circuit 38. The read/write channel circuit 38 is coupled to media 40 on which data is stored within the media storage device 50. The read/write channel circuit 38 controls the storage operations on the media 40, including reading data from the media 40 and writing data to the media 40. An external controller 60 is coupled to the buffer controller 34 for controlling the processing, classifying and indexing of data streams stored on the media 40.

Preferably, the external controller 60 is external to the media storage device 50 and is responsible for processing the data stream according to the present invention. This processing includes classifying and indexing the data stream based on the content within the data stream and occurrences of certain identified content within the data stream, as will be described below. As illustrated in FIG. 3, the external controller 60 communicates with the media storage device 50 through a direct connection to the buffer controller 34. Alternatively, the external controller 60 communicates with the media storage device 50 through any appropriate connection, including over the IEEE 1394-2000 serial bus. Alternatively, the controller 60 is within the media storage device 50. Also, while the preferred embodiment of the present invention is discussed relative to storing the audio/video data stream and the index database on a media storage device, such as a hard disk drive, it should be apparent that alternatively, the audio/video data stream and/or the index database could be stored on any appropriate storage circuit or device, including RAM, ROM, flash memory, EPROM, EEPROM, tape drive, CD-ROM and DVD.

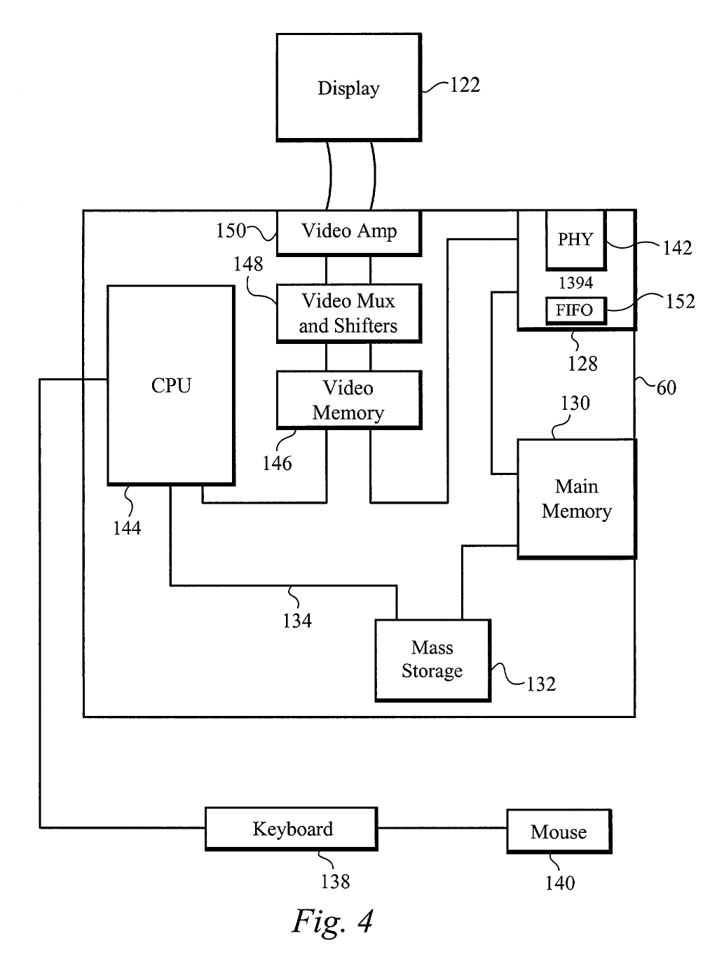

The external controller 60 is preferably, any device or system capable of implementing the recognition technology, as discussed below, and processing the data stream according to the present invention. A block diagram of the internal components of an exemplary computer system 20, capable of performing the functions of the external controller 60 of the preferred embodiment of the present invention, is illustrated in FIG. 4. The computer system 60 includes a central processor unit (CPU) 144, a main memory 130, a video memory 146, a mass storage device 132 and an IEEE 1394-2000 interface circuit 128, all coupled together by a conventional bidirectional system bus 134. The interface circuit 128 includes the physical interface circuit 142 for sending and receiving communications on the IEEE 1394-2000 serial bus. The system bus 134 contains an address bus for addressing any portion of the memory 130 and 146. The system bus 134 also includes a data bus for transferring data between and among the CPU 144, the main memory 130, the video memory 146, the mass storage device 132 and the interface circuit 128.

The computer system 60 is also coupled to a number of peripheral input and output devices including the keyboard 138, the mouse 140 and the associated display 122. The keyboard 138 is coupled to the CPU 144 for allowing a user to input data and control commands into the computer system 60. A conventional mouse 140 is coupled to the keyboard 138 for manipulating graphic images on the display 122 as a cursor control device. As is well known in the art, the mouse 140 can alternatively be coupled directly to the computer 120 through a serial port.

A port of the video memory 146 is coupled to a video multiplex and shifter circuit 148, which in turn is coupled to a video amplifier 150. The video amplifier 150 drives the display 122. The video multiplex and shifter circuitry 148 and the video amplifier 150 convert pixel data stored in the video memory 146 to raster signals suitable for use by the display 122.

According to the present invention, an audio/video content stream of data is processed to generate an index database, which can then be used to quickly locate and navigate to specific occurrences of content and objects within the audio/video content stream. Preferably, the content stream is processed while it is being recorded to generate the index database of the content and objects within the stream. Alternatively, the processing occurs offline after the content stream is recorded. This alternative embodiment of offline processing after the content stream is recorded, is necessary in systems or devices which do not have the processing power or speed to support the recognition engine utilized in the present invention, to process the stream in realtime, while the content stream is being recorded.

The processing to generate an index database corresponding to a content stream, includes utilizing a recognition engine or recognition technology to analyze the content stream and identify occurrences of specified objects or content within the content stream. The term object will be used herein to describe any identifiable information within a content stream, including shapes, objects, movements and events within video streams and sounds, words and utterances within audio streams. Any currently available recognition technology can be used to analyze the content stream and identify the occurrence of specified objects within the content stream. Using such technology, previously identified objects are identified as the content stream is processed. This type of recognition technology relies on the user to identify the objects that the user is interested in indexing, before the content stream is processed. Using more capable recognition technology, having some artificial intelligence components, classes of objects and events are dynamically identified by the recognition technology as the content stream is processed.

As the stream is processed, the recognition engine within the controller 60 analyzes the content within the content stream to identify the appropriate objects within the content stream. As described above, the appropriate objects are either identified by the user before the content stream is processed, are dynamically identified by the recognition engine during processing, or some combination of identification by the user and dynamic identification is implemented by the recognition engine. As appropriate objects within the content stream are identified, the occurrence of those identified objects within the content stream is then recorded within an index database. Once the content stream is processed and the index database is generated, the user then has the capability to jump to locations within the content stream where the desired object occurs, for listening to, viewing or editing the content stream.

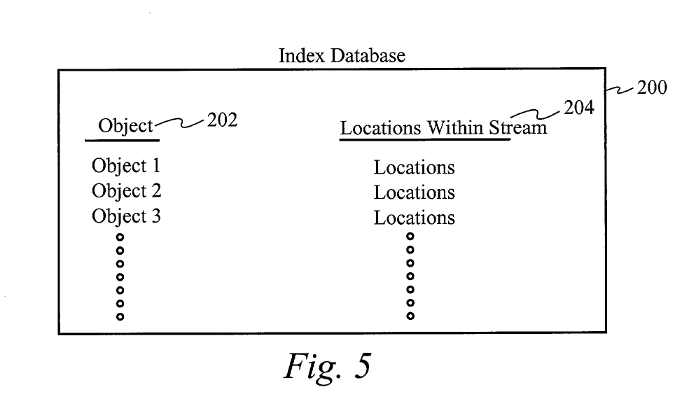

An index database according to the preferred embodiment of the present invention is illustrated in FIG. 5. The index database 200 includes an object category 202 and a corresponding location category 204. Each entry within the index database 200 includes an object identifier within the object category 202 and a list of one or more locations, within the content stream where the object identified by the object identifier occurs, in the corresponding location category 204. Each of the list of one or more locations, preferably includes a storage device identifier, track name and a time value identifying where the occurrences of the object are stored. Alternatively, the list of one or more locations includes frame numbers or memory locations where the occurrences of the object are stored within the memory or device.

Preferably, the index database 200 is stored on the same memory storage device 50 as the content stream. Alternatively, the index database 200 is stored on a different memory storage device than the content stream, including a remote device, accessed through a network or over the internet.

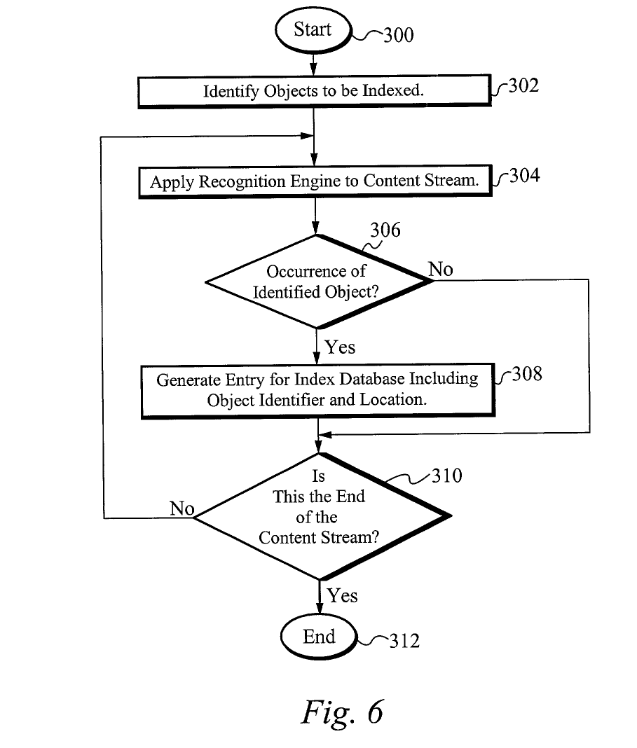

A flowchart showing the preferred steps implemented by the controller 60 and the media storage device 50 during processing of a content stream to generate an index database is illustrated in FIG. 6. The process starts at the step 300. At the step 302, the objects to be indexed and included in the index database are identified. As described above, this identification is performed by the user before processing and/or dynamically by the recognition technology during processing. At the step 304, the recognition engine or recognition technology is then applied to the content stream to analyze the content stream and determine the occurrence of identified objects within the content stream.

At the step 306, it is determined whether the content within the content stream that is currently being analyzed includes an identified object. If the content currently being analyzed does include an identified object, then at the step 308, an entry is generated for the index database 200, including the object identifier entry within the object category 202 and an entry identifying the corresponding location of the content within the location category 204. After the generation of the entry for the index database at the step 308, or if it is determined at the step 306, that the content currently being analyzed does not include an identified object, it is then determined at the step 310, if there is more content within the content stream, or if this is the end of the content stream. If it is determined that the content stream has not yet been fully processed, then the process jumps back to the step 304, to continue processing the content stream. If it is determined at the step 310 that all of the content stream has been processed, then the process ends at the step 312.

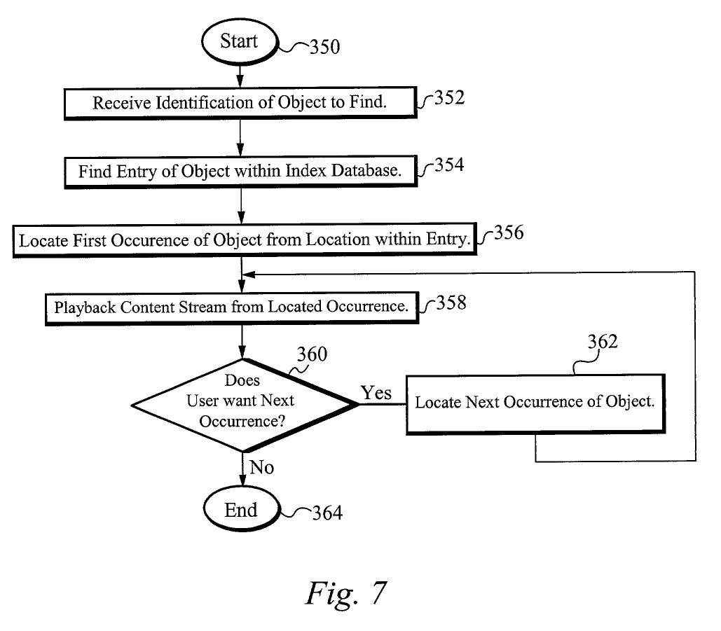

A flowchart showing the preferred steps implemented by the controller 60 and the media storage device 50 during playback of a content stream, that has a corresponding index database according to the present invention, is illustrated in FIG. 7. The process starts at the step 350. At the step 352, a user identifies an object that they would like to locate within the content stream. At the step 354, the entry corresponding to the identified object is located within the index database 200 and the location of the first occurrence of the object is targeted, using the entries from the object category 202 and the location category 204. At the step 356, the first occurrence of the object is located within the content stream. At the step 358, this occurrence of the object is then played back for the user. At the step 360, it is then determined if the user wants the next occurrence of the object located and played back. If the user does want the next occurrence of the object located and played back, then the next occurrence of the object is located at the step 362. The process then jumps to the step 358 to playback this next occurrence. If it is determined at the step 360 that the user does not want the next occurrence of the object located and played back, the process then ends at the step 364.

As an example of the operation of the content recognition system and index database of the present invention, a user records a video of their child's birthday on a tape within a video recorder. This video includes audio and video components. The video is then recorded from the tape to a media storage device 50. Under the control of the controller 60 in conjunction with the media storage device 50, the video is processed to generate the index database 200 by applying recognition technology to the video and audio components to determine each occurrence of an identified object within the content stream. As described above, this processing occurs either as the video is recorded on the media storage device 50, if the user's system has the processing capability to perform the processing online, or after the video is stored on the media storage device 50. During processing the video is analyzed to determine each occurrence of an identified object. As an occurrence of an identified object is found within the video, an entry corresponding to that occurrence is then added to the index database. For example, if the user identifies that they want every occurrence of a birthday cake within the video indexed, the recognition technology is then applied to the video content stream to determine every occurrence of the birthday cake within the video. These occurrences are identified and indexed within the index database, as described above. If the user then wants to view these occurrences or edit the video based on these occurrences, the system will utilize the index database to playback these occurrences of the birthday cake within the video or edit the video based on the occurrences of the birthday cake within tie video.

Utilizing the content recognition system and content index database of the present invention, a content stream of data is processed to generate the content index database. The content stream is processed by applying recognition technology to the content within the content stream to identify and index occurrences of identified objects. Preferably, the content stream is processed as the content stream is stored within a media storage device. Alternatively, the content stream is processed after the content stream is stored within the media storage device. The objects that are included within the index database, are either identified by the user before processing or are identified dynamically by the recognition technology during processing. Once the content index database is generated, it can then be used to quickly locate and navigate to specific occurrences of content and objects within the content stream. The objects that can be identified and indexed preferably include any identifiable information within a content stream, including shapes, objects, events and movements within video streams and sounds, words and utterances within audio streams.

The present invention has been described in terms of specific embodiments incorporating details to facilitate the understanding of principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention. Specifically, it will be apparent to those skilled in the art that while the illustrated embodiment utilizes an IEEE 1394-2000 serial bus structure, the present invention could also be implemented on any other appropriate digital interfaces or bus structures, or with any other appropriate protocols.

I claim:

1. A method of generating an index database representing a content stream, the method comprising:
a. receiving a content stream;
b. processing the content stream to determine occurrences of one or more objects within the content stream; and
c. generating an entry within an index database for each occurrence of the one or more objects.

2. The method as claimed in claim 1 wherein the entry includes an object identifier and a corresponding location of the occurrence of the object within the content stream.

3. The method as claimed in claim 2 further comprising playing back the content stream beginning at the location corresponding to a next occurrence of a specified object.

4. The method as claimed in claim 1 further comprising storing the content stream.

5. The method as claimed in claim 4 further comprising storing the index database.

6. The method as claimed in claim 1 further comprising storing the index database.

7. The method as claimed in claim 1 further comprising identifying the objects before the processing is performed.

8. The method as claimed in claim 1 further comprising identifying the objects during the processing.

9. The method as claimed in claim 1 wherein the objects include one or more of shapes, objects, events and movements.

10. The method as claimed in claim 1 wherein the objects include one or more of sounds, words and utterances.

11. The method as claimed in claim 1 wherein the content stream includes one or more of an audio component and a video component.

12. A method of processing a content stream comprising:
a. processing a content stream to determine occurrences of one or more objects within the content stream; and
b. generating an entry for each occurrence of the one or more objects, the entry including an object identifier and a corresponding location of the occurrence of the object within the content stream.

13. The method as claimed in claim 12 further comprising receiving the content stream.

14. The method as claimed in claim 12 further comprising saving the entry within an index database.

15. The method as claimed in claim 12 further comprising storing the content stream.

16. The method as claimed in claim 12 further comprising identifying the objects before the processing is performed.

17. The method as claimed in claim 12 further comprising identifying the objects during the processing.

18. The method as claimed in claim 12 wherein the objects include one or more of shapes, objects, events and movements.

19. The method as claimed in claim 12 wherein the objects include one or more of sounds, words and utterances.

20. The method as claimed in claim 12 wherein the content stream includes one or more of an audio component and a video component.

21. A method of playing back a content stream from an occurrence of an object comprising:
a. locating an entry within an index database corresponding to the content stream, the entry including an object identifier and a corresponding location of the occurrence of the object within the content stream; and
b. playing back the content stream beginning at the location corresponding to a next occurrence of a specified object.

22. The method as claimed in claim 21 wherein the objects include one or more of shapes, objects, events and movements.

23. The method as claimed in claim 21 wherein the objects include one more of sounds, words and utterances.

24. The method as claimed in claim 21 wherein the content stream includes one or more of an audio component and a video component.

25. An apparatus for processing a content stream comprising:
a. means for processing a content stream to determine occurrences of one or more objects within the content stream; and
b. means for generating an entry coupled to the means for processing for generating an entry for each occurrence of the one or more objects, the entry including an object identifier and a corresponding location of the occurrence of the object within the content stream.

26. The apparatus as claimed in claim 25 further comprising means for receiving coupled to the means for processing for receiving the content stream.

27. The apparatus as claimed in claim 26 further comprising means for storing coupled to the means for receiving for storing the content stream.

28. The apparatus as claimed in claim 27 wherein the means for storing includes a hard disk drive.

29. The apparatus as claimed in claim 25 further comprising means for storing coupled to the means for generating for saving the entry within an index database.

30. The apparatus as claimed in claim 29 wherein the means for storing includes a hard disk drive.

31. The apparatus as claimed in claim 25 wherein the objects are identified before the content stream is processed by the means for processing.

32. The apparatus as claimed in claim 25 wherein the objects are identified by the means for processing as the content stream is processed by the means for processing.

33. The apparatus as claimed in claim 25 wherein the means for processing includes a recognition engine.

34. The apparatus as claimed in claim 33 wherein the recognition engine incorporates one or more of speech recognition, voice recognition and visual recognition.

35. The apparatus as claimed in claim 25 wherein the objects include one or more of shapes, objects, events and movements.

36. The apparatus as claimed in claim 25 wherein the objects include one or more of sounds, words and utterances.

37. The apparatus as claimed in claim 25 wherein the content stream includes one or more of an audio component and a video component.

38. An apparatus to process a content stream comprising:
a. a processing engine to process a content stream to determine occurrences of one or more objects within the content stream; and
b. a controller coupled to the processing engine to generate an entry for each occurrence of the one or more objects, the entry including an object identifier and a corresponding location of the occurrence of the object within the content stream.

39. The apparatus as claimed in claim 38 further comprising an interface coupled to the processing engine configured to receive the content stream.

40. The apparatus as claimed in claim 39 further comprising a storage device coupled to the interface to store the content stream.

41. The apparatus as claimed in claim 40 wherein the storage device includes a hard disk drive.

42. The apparatus as claimed in claim 40 wherein the storage device is remote from the processing engine and the controller.

43. The apparatus as claimed in claim 40 wherein the storage device is coupled to the processing engine and the controller over an IEEE 1394 serial bus network.

44. The apparatus as claimed in claim 38 further comprising a storage device coupled to the controller to save the entry within an index database.

45. The apparatus as claimed in claim 44 wherein the storage device includes a hard disk drive.

46. The apparatus as claimed in claim 38 wherein the objects are identified before the content stream is processed by the processing engine.

47. The apparatus as claimed in claim 38 wherein the objects are identified by the processing engine as the content stream is processed by the processing engine.

48. The apparatus as claimed in claim 38 wherein the processing engine includes a recognition engine.

49. The apparatus as claimed in claim 48 wherein the recognition engine incorporates one or more of speech recognition, voice recognition and visual recognition.

50. The apparatus as claimed in claim 38 wherein the objects include one or more of shapes, objects, events and movements.

51. The apparatus as claimed in claim 38 wherein the objects include one or more of sounds, words and utterances.

52. The apparatus as claimed in claim 38 wherein the content stream includes one or more of an audio component and a video component.

53. An index database corresponding to a content stream comprising a plurality of entries, each entry including an object identifier and a corresponding location of an occurrence of an object within the content stream.

54. The index database as claimed in claim 53 wherein the objects include one or more of shapes, objects, events and movements.

55. The index database as claimed in claim 53 wherein the objects include one or more of sounds, words and utterances.

56. The index database as claimed in claim 53 wherein the content stream includes one or more of an audio component and a video component.

57. The index database as claimed in claim 53 wherein the entries are stored on a storage device.

58. The index database as claimed in claim 57 wherein the storage device is hard disk drive.

59. A storage device configured to store and process a content stream comprising:
a. a processing engine to process a content stream to determine occurrences of one or more objects within the content stream;
b. a controller coupled to the processing engine to generate an entry for each occurrence of the one or more objects, the entry including an object identifier and a corresponding location of the occurrence of the object within the content stream; and
c. a storage element coupled to the processing engine and to the controller to store the content stream and the entries.

60. The storage device as claimed in claim 59 wherein the processing engine and the controller are remote from the storage element.

61. The storage device as claimed in claim 59 wherein the processing engine and the controller are coupled to the storage element over an IEEE 1394 serial bus network.

62. The storage device as claimed in claim 59 further comprising an interface coupled to the processing engine and configured to receive the content stream.

63. The storage device as claimed in claim 62 wherein the interface receives the content stream over an IEEE 1394 serial bus network.

64. The storage device as claimed in claim 59 wherein the storage element includes a hard disk drive.

65. The storage device as claimed in claim 59 wherein the objects are identified before the content stream is processed by the processing engine.

66. The storage device as claimed in claim 59 wherein the objects are identified by the processing engine as the content stream is processed by the processing engine.

67. The storage device as claimed in claim 59 wherein the processing engine includes a recognition engine incorporating one or more of speech recognition, voice recognition and visual recognition.

68. The storage device as claimed in claim 59 wherein the objects include one or more of shapes, objects and movements.

69. The storage device as claimed in claim 59 wherein the objects include one or more of sounds, words and utterances.

70. The storage device as claimed in claim 59 wherein the content stream includes one or more of an audio component and a video component.

71. A network of devices comprising:
a. a source device for transmitting a content stream;
b. a storage device coupled to the source device to receive and store the content stream; and
c. a controller coupled to the storage device to process the content stream to determine occurrences of one or more objects within the content stream and generate entries corresponding to the occurrences of the one or more objects, each of the entries including an object identifier and a corresponding location of the occurrence of the object within the content stream.

72. The network of devices as claimed in claim 71 wherein the storage device is a hard disk drive.

73. The network of devices as claimed in claim 71 wherein the objects are identified before the content stream is processed.

74. The network of devices as claimed in claim 71 wherein the objects are identified by the controller as the content stream is processed.

75. The network of devices as claimed in claim 71 wherein the controller includes a recognition engine incorporating one or more of speech recognition, voice recognition and visual recognition.

76. The network of devices as claimed in claim 71 wherein the objects include one or more of shapes, objects, events and movements.

77. The network of devices as claimed in claim 71 wherein the objects include one or more of sounds, words and utterances.

78. The network of devices as claimed in claim 71 wherein the content stream includes one or more of an audio component and a video component.

79. The network of devices as claimed in claim 71 wherein the entries are stored on the storage device within an index database.

80. The network of devices as claimed in claim 71 wherein the source device is coupled to the storage device over an IEEE 1394 serial bus network.

81. The network of devices as claimed in claim 71 wherein the storage device is coupled to the controller over an IEEE 1394 serial bus network.

82. The network of devices as claimed in claim 71 wherein the storage device is remote from the controller.
